(19) United States
(12) Patent Application Publication
(10) Pub. No.: US 2010/0281154 A1
(43) Pub. Date: Nov. 4, 2010

(54) Methods and Apparatus for Remote Monitoring

(75) Inventors: Bharat Veer Bedi, Portsmouth (GB); David C. Conway-Jones, Winchester (GB); David Locke, Chandler's Ford (GB); Andrew James Stanford-Clark, Chale (GB)

Correspondence Address: RSW IP Law;IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS CORPORATION, ARMONK (NY)

(21) Appl. No.: 12/095,504

(22) PCT Filed: Dec. 1, 2006
(86) PCT No.: PCT/EP06/69225

§ 371 Date: May 30, 2008

(30) Foreign Application Priority Data
Dec. 3, 2005 (GB) 0524742.4

(51) Int. Cl. G06F 15/16

(52) U.S. Cl. 709/224

(57) ABSTRACT

Provided are methods, apparatus and computer programs for remote monitoring of data. Log data output by an application program running on a storage-constrained apparatus is saved to local system memory—either as an in-memory data file or as output from one application piped to the input of another, or as a named pipe that passes data to a local publisher program—and then captured by the local publisher program. The local publisher program sends the data to a publish/subscribe broker, which can retain the most recent publications for analysis by one or more subscribers. This avoids the need to save large amounts of data to disk storage on the storage-constrained apparatus, and ensures that console output data and log data that is often discarded by headless, storage-constrained systems is available for analysis. The combination of the retain feature and publishing of output data in response to failure of a monitoring application ensures the availability of the data that was output just before the failure, which is generally the most useful data for problem diagnosis.

### FIELD OF INVENTION

The present invention relates to remote monitoring of data, such as for monitoring equipment parameters or the output of an application program running on a remote data processing device.

### BACKGROUND

When there is a need to monitor data output by an application program, it is sometimes possible to save the application program's output to a file in non-volatile storage. The saved data may include log records that represent selected events and outputs. If the application program fails, data within a saved log file can be reviewed to help determine what went wrong and to aid recovery. In particular, the last few lines of the log file often give valuable clues about why the application failed. Therefore, if the device running the application has adequate non-volatile storage for storing log records, problems can be diagnosed by analysing data saved to the local log file.

In recent years, there has been a proliferation of pervasive and embedded data processing devices—such as mobile phones and PDAs, devices monitoring equipment parameters and climate conditions, flow rate monitors within oil pipelines and other remote and inhospitable environments; and data processing components embedded within cars, refrigerators, alarm systems and climate control systems for man-made environments. Many of these pervasive and embedded devices have very limited memory space and little or no non-volatile storage, such that very little information can be maintained for subsequent error analysis.

It is impossible to maintain an adequate log file on some pervasive devices, since the required storage space may run to many megabytes and the available storage may quickly fill up. Secondly, any data saved in volatile RAM will not survive a device or application failure—only log records saved to non-volatile storage will be available for analysis of the failure.

Some applications assume the existence of a local console display on which to output diagnostic messages. Such applications are often run with minimal alteration on embedded devices that have no console display. Since many embedded devices and remote monitoring apparatus have no console display and have insufficient storage for log records to be written, diagnostic information is often discarded and the potential benefits of generating this information are lost.

### SUMMARY

A first aspect of the present invention provides a method for remote monitoring of log data that is generated by an application program, comprising the steps of:

saving log data that is generated by the application program to a memory of a first data processing system that is local to the application program; and

the steps, performed by a publisher program running on the first data processing system, of: capturing newly saved log data from the memory; and iteratively transmitting the captured log data, as a sequence of publications, to a second data processing system including a publish/subscribe message broker.

The application program may be running on a storage-constrained data processing apparatus—i.e. a data processing system that has no writable non-volatile storage (i.e. volatile RAM only), or has only limited writable volatile memory and non-volatile storage such that it is necessary to control the amount of output data stored on the apparatus at any one time.

The invention captures data that is generated by the application program for saving to a log file or for display as a console output, such as diagnostic information or system alerts or other event-specific outputs associated with the operation of the application program. Such data is referred to as log data herein. The application may be a data logger whose purpose is to gather data locally over a significant period of time, to enable later analysis. Some application programs generate such log data on a headless system where it cannot be displayed, or on a system which has insufficient storage capacity to save adequate log data locally.

By capturing and iteratively publishing log data, the invention avoids the need to retain large log data files at a storage-constrained apparatus, and can avoid the need to save such data to disk storage at the storage-constrained apparatus. The data that has been saved to memory, captured from memory and published can then be overwritten in memory. The invention also enables a more frequent transmission of log data to a remote system than is expected by the application program that is writing log data.

The application program may be monitoring a sensor or meter output, or other locally-generated data, and generating log data that cannot be displayed on a local console display or saved to local non-volatile disk storage. Alternatively, the application program may be a dedicated logger application. The log data is not discarded but is transmitted to a publish/subscribe message broker running on a remote system, and this can be achieved without recoding the application program. The data is transmitted as a sequence of publications on a topic (or more than one topic) that can be recognised by a publish/subscribe matching engine within the broker and forwarded to a subscriber that has subscribed to receive publications on that topic. There may be more than one registered subscriber to whom the publications are passed for analysis and/or storage (which contrasts with most telemetry systems that provide their data to a single application only).

In one embodiment of the invention, the application program running on a storage-constrained apparatus saves its log data to a ‘circular’ data file in volatile memory of the storage-constrained apparatus. A ‘circular’ data file is one which is overwritten, starting by overwriting the oldest data first, when any new data is written to the file after the file has used all of the memory space allocated to it. This is one possible mechanism for managing the size of the log file. An iterative extraction of new log data is then performed, for example by tailing the circular log file. The tailing is performed by the publisher program that iteratively generates publications to send the new log data to a remote system.

The frequency of data extraction and publication is controlled to ensure that no required data is overwritten before being published. More specifically, the frequency of generation of publications may be associated with the amount of log data being generated. There are various options for achieving this—such as the publisher generating a publication after a required number of lines or bytes of data have been saved to the log file since the last publication was generated and sent. Generation of a publication may also be triggered by identification of certain keywords being added to the log, or on expiry of a time period since the last publication was sent.

In an alternative embodiment, instead of the publisher tailing an in-memory file, new log data output by a first application program running on a storage-constrained apparatus is ‘piped’ to a publisher application. Thus, the publisher program may actively capture newly saved log data by tailing a log file, or may capture data more passively if the log data output by an application is piped directly into the input of the publisher program, or the log data may be saved to a named pipe between the application program and the publisher.

In one embodiment, the publisher application generates and sends new publications to a remote system via a messaging client (or another communication handler component) that is also running on the storage-constrained apparatus. This facilitates integration of the output data from a wide variety of data gathering devices using simple publisher applications within a publish/subscribe messaging network. The messaging client handles routing of the publications (with support from any message managers on intermediate network nodes within the network) to a publish/subscribe message broker on the remote system. A publish/subscribe matching engine within the broker can then compare a topic name (or other contents) of a received publication with a set of subscriptions that associate topics (or other contents) with subscribers, thereby to identify one or more subscribers to forward the publication to.

The invention provides improved availability of log data and data generated for a console display. This is beneficial if a failure occurs at the storage-constrained apparatus, and is particularly advantageous if the local apparatus does not have the capacity to store adequate log records or has no non-volatile storage. The use of publish/subscribe communications provides flexibility regarding which (and how many) applications process the log data, and facilitates remote analysis of problems.

The publishing step may be performed at regular or irregular time intervals. An example of the latter is an implementation which sends a publication or batch of publications when the captured new data reaches a predefined size limit, although another example sends a publication in response to each new entry being added to the in-memory data file.

In one embodiment of the invention, captured log data is transmitted to a message broker that includes a ‘retain’ mechanism and provides assured message delivery—such as using the ‘retain’ flag of IBM's WebSphere MQ Telemetry Transport protocol, as implemented within WebSphere message broker products from IBM Corporation. WebSphere and IBM are registered trademarks of International Business Machines Corporation in the US and other countries. When the ‘retain’ option is selected by a publisher, the last message published on each topic is held in the message broker.

In typical messaging environments, an ability to retain the last published message at a broker has been considered desirable because it enables any new subscribers to the relevant message topic to obtain the most recently-available data straight away—without having to wait for a new publication. Thus, the retained last message is assumed to be the last known “good data”. However, when used in an embodiment of the present invention in which the published data includes diagnostic information, the retain mechanism can provide useful information if the storage-constrained apparatus experiences a failure. That is, the last successfully transmitted publication can provide valuable information about the apparatus just before the failure—which is not merely the most recent data but is also likely to be the most crucial data for diagnosing the failure.

A second aspect of the invention provides a data processing system comprising:

a system memory;

a first application program configured to save log data to the system memory;

a publisher program configured to capture newly saved log data from the system memory and to iteratively transmit the newly captured log data, as a sequence of publications, to a publish/subscribe message broker.

The publish/subscribe message broker typically comprises a computer program that implements a message communication protocol and message routing functions as well as a publish/subscribe matching engine, and is running on a separate data processing apparatus.

A third aspect of the invention provides a publisher computer program as identified above, for use in a monitoring method according to the invention. The publisher computer program may be made available as program code recorded on a recording medium or may be made available for download via a communications network.

### BRIEF DESCRIPTION OF DRAWINGS

Embodiments of the invention are described in more detail below, by way of example only, with reference to the accompanying drawings in which:

FIG. 1 is a schematic representation of a distributed network in which publisher applications and subscriber applications are running on remote systems and communicate with each other via an intermediate publish/subscribe broker, such as is known in the art;

FIG. 2 is a schematic representation of two remote data processing systems, showing a set of computer programs and storage components, according to an embodiment of the invention;

FIG. 3 shows a system according to a second embodiment of the invention;

FIG. 4 is a flow diagram representing a sequence of operations performed by the data processing systems of FIG. 2; and

FIG. 5 is an example representation of the results of processing and publishing data from a Web log.

### DETAILED DESCRIPTION OF EMBODIMENTS

Many application programs output information for display on a console display—the display unit of the apparatus on which the application is running (or the window in which the application is running). This information usually scrolls up as new data is added, such that the oldest data is lost from view—but the last “screen” of information is available for viewing. This has two advantages. Firstly, a user can see the latest events or system parameters as they are reported. Secondly, if the application stops due to a fault, the last screen of information is available for viewing to help determine the problem.

However, many computers such as computers embedded in other apparatus do not have a display unit attached to them (such systems are referred to as “headless”). Another issue is that it is not always possible for a human user to view displayed information at the required time. It is usually possible to redirect the console output to a log file in non-volatile storage which can be saved and viewed later. However, many pervasive devices have little or no storage available to store such a log file.

A monitoring solution is therefore required for storage-constrained headless systems and for storage-constrained systems which are not easily accessible to users. The present invention addresses this problem with a solution based on specialist publish/subscribe technology.

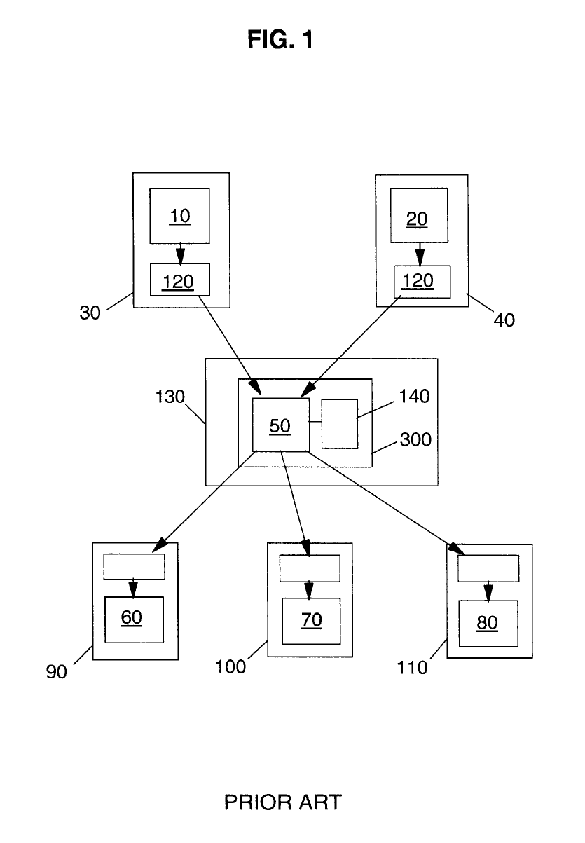

A conventional distributed publish/subscribe communications network is shown in FIG. 1. One or many publisher application programs 10, 20 are each running on a respective data processing apparatus 30, 40, and are sending publications to a message broker that includes a subscription matching engine 50. One or many subscribers 60, 70, 80 run on respective data processing systems 90, 100, 110 and have registered with the subscription matching engine 50—providing their network address information and any other communication requirements. In a topic-based publish/subscribe network, the subscribers specify topics for publications that they wish to receive. The publishers 10,20 (or messaging middleware 120 associated with the publishers) know how to reach the subscription matching engine and include topic identifiers within their publications (for example in message headers). The publishers are not required to know network addressing information for the subscribers—or even their identities. The subscription matching engine 50 typically comprises part of a message broker program that also handles network routing. The message broker runs on a data processing system 130 at an intermediate network location separate from the publishers and subscribers, and greatly simplifies communications for the publishers and subscribers. The subscription matching component compares topic names in each received publication with a stored list 140 of topic names and forwards the publications to subscribers that have indicated a desire to receive publications on that topic.

In other environments, an instance of a subscription matching component may be running on each subscriber system, and is used to identify publications of interest to a local subscriber.

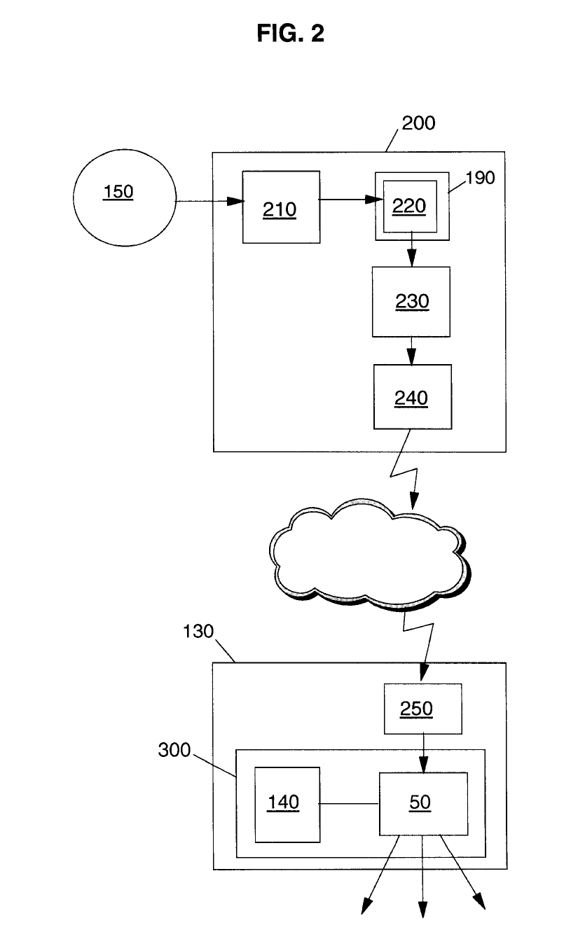

FIG. 2 includes a schematic representation of a monitoring apparatus 200 according to an embodiment of the invention. The monitoring apparatus in this example is a headless data processing system that has only a limited data storage capacity. The monitoring apparatus 200 includes a publishing capability for transmitting log data, output by monitoring and control applications, to a publish/subscribe message broker system 300. The publications sent to the broker system 300 contain log data captured from a monitoring application program 210 running on the system 200. For example, the publisher system 200 may be a data processing apparatus connected to a sensor 150 within an oil or gas pipeline for the specific purpose of monitoring the flow rate and other parameters of the fluid within the pipe. Other example publisher systems include an automated meter reading system, and a weather monitoring system including sensors that provide data on wind speed and direction, rainfall, temperature, humidity and barometric pressure. In the latter example, there may be a separate monitoring application program for each sensor. There may also be several applications generating output data in a home automation system that combines monitoring and control with smart appliance integration and alarm/alert generation.

It is known in the art for application programs to send messages containing their output data to a message broker, which forwards the messages to remote system (for example, using a publish/subscribe matching mechanism to identify subscribers who require messages on a topic specified within a particular publication). However, the present invention makes use of publish/subscribe mechanisms to provide access to an application's log data that conventionally would be saved to a local log file, and achieves this for remotely located, headless devices that do not have sufficient non-volatile storage capacity to store a large log file locally.

The invention may be applied to data generated by a dedicated logger application—which would conventionally save a large amount of log data locally for later analysis. By capturing and iteratively publishing the data, with much greater frequency than is expected by the logger application, the invention avoids the need to save very large log files on the originating system.

In a first embodiment, the monitoring application 210 saves its generated log data to a ‘circular’ data file 220 within local volatile RAM of the monitoring apparatus 200. It is known for some applications to use a fixed-size file as a log file, and then to use this log file in a ‘circular’ fashion—overwriting the file from the beginning when the file has reached the limit of its fixed size. This has the advantage that the file cannot grow above the specified size, and so cannot fill the file system. Secondly, the most recently written data is available for inspection if the application terminates abnormally. In known systems, this availability is achieved by creating the log file in non-volatile disk storage. However, according to an embodiment of the present invention, the circular log file 220 is held in volatile memory instead of disk storage, and is itself being monitored by a publishing program 230 (referred to hereafter as ‘Pubtail’ for ease of reference).

The filename of the circular log file of the monitoring application 210 is specified to Pubtail 230, which can then use appropriate file access commands (“seek”) to enable Pubtail to constantly monitor the last-written part of the file without encountering an EndOfFile condition.

Alternatively, if the log file 220 is an ever-expanding file, the most-recently written data can be captured in real time by tailing the end of the file, using a command such as:

tail -f log.file | pubtail

Alternatively, log entries may be provided to Pubtail on its standard input stream (directly piped from the application into Pubtail) using:

application | pubtail

Pubtail can then process the data for publication as described below.

A number of utilities for tailing files (using tail -f) are already known in the art. For example, when direct access to the file system that stores each log file is available, a tool such as JLogTailer (a Java™ log tailing tool) can be used. This example is described together with other Internet/file tools at Website www.jibble.org. Functions similar to known tailing tools can be used for the data capture step that integrates with publisher features of the present invention.

An implementation of the Pubtail program of the present invention includes, in addition to a data capture capability that is similar to known tailing programs, a publishing capability for iteratively publishing extracted chunks of output data. In the present solution, the data capture component 230 of the Pubtail program interfaces with a lightweight messaging client component 240 to transmit recently captured data and a topic name to a subscription matching component of a publish/subscribe message broker. The data capture component 230 and messaging component 240 of Pubtail may comprise two integrated components of a single computer program or two separate programs.

In the present embodiment, the messaging client 240 implements the WebSphere MQ Telemetry Transport (MQTT) protocol developed by IBM Corporation. The MQTT protocol provides publish/subscribe messaging over TCP/IP, with various options for the level of assurance of delivery, and was designed for the specialized client devices and network types found in telemetry integration applications. MQTT minimizes network bandwidth, requiring only two bytes of data as the header overhead associated with the data contents of a message.

The publisher functions of Pubtail can operate in two distinct modes, according to the nature of the output of the application program, to ensure that data is published before it is lost from the originating system:

1) Publish every N lines of output (for example every 1 line). In this case, Pubtail 230 waits until it has captured the specified number of new-line-delimited lines of console output from the monitoring application 210. Pubtail 230 then publishes a message that contains those lines of information and contains a pre-assigned topic identifier. The message is sent to the message broker system 300.

2) Publish every M bytes of output. In this case, Pubtail consumes data from the output of the monitoring application program, ignoring line breaks, until it has M bytes (for example 1 kB) of data, and then publishes a message to the broker containing that data.

There is an optional timeout on both of these modes. If the timeout is not set, Pubtail waits until it has captured the stipulated number of bytes or lines. If the timeout is set, and Pubtail has not captured the stipulated number of bytes or lines by the specified time, Pubtail sends a message to the publish/subscribe broker system that contains whatever data Pubtail has captured since its last publication of a message. This avoids Pubtail introducing inappropriate delays into the system. Pubtail can also be configured to respond to particular keywords or phrases appearing in a log.

In addition to the above-described solutions that involve writing log data output by a monitoring application to a log file in memory and then tailing this file, other embodiments are within the scope of the present invention. In UNIX™ systems (such as Linux™ systems) the output from one application can be piped directly to the input of another application—copying the standard output stream of the first application to the standard input stream of the publisher program. Alternatively, log data may be saved to a ‘named pipe’, which is a memory-based queue that appears in the file system with a file name. If this queue is a named output file for a first application program, any data written by this first application to the queue can be retrieved by another application program that reads from the queue by opening the named pipe for input.

By creating an input queue in memory for a publisher application, and specifying this input queue as a named output file to which a monitoring application outputs data, data output by the monitoring application is “piped” to the publisher application. The publisher application sends the data onwards via a network of data processing systems to a publish/subscribe broker, which asynchronously forwards the data to one or more subscriber applications. In this way, monitoring applications can be used on devices that have little or no disk storage—avoiding the potential problem of the monitoring application's output data filling the file system.

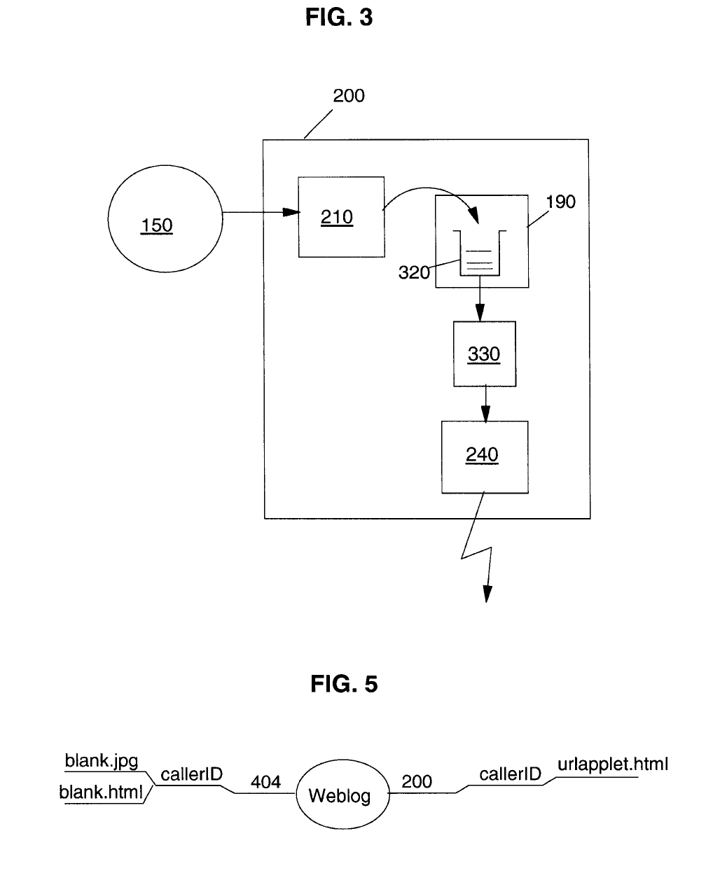

FIG. 3 is a schematic representation of a system in which a monitoring application 210 outputs data to a named pipe 320. The data is captured by data capture component 330 of a publisher application, and is published via a messaging client 240 of the publisher application. The publisher application receives input—line by line as the output data is produced—from the monitoring application 210. In this way, the publisher application receives the same data as a human user would see if the user could observe a console monitor to which the monitoring application sends its output. For ease of reference, and because the following description is applicable to either of the above-described implementations of the publisher application, this publisher application 330 will again be referred to as Pubtail hereafter.

Pubtail includes an additional feature that can be useful for problem diagnosis. If the application being monitored exits for some reason (usually a failure causing an abnormal exit), Pubtail will then publish a message to the publish/subscribe broker system. This message will contain the last messages of the application's output, which may be the most critical data for problem diagnosis. For example, if Pubtail is set to publish every 100 lines, and the application fails 50 lines into a new batch, Pubtail sends those 50 lines when the application exits. Pubtail receives an EndOfFile message on its input stream, by which it identifies the application exiting and then publishes its last buffer of data. The EndOfFile marker is placed in the input stream by the operating system when the application exits. Pubtail can be configured to exit itself at this point (i.e. in response to an application exit event being recognised by the EndOfFile), which automatically generates a status message to be sent to the publish/subscribe broker system. This status message can serve as an alert to a remote system operator or administrator. The status message can be as simple as Pubtail sending a 1 or a 0 (active or exited) to a status topic. Thus, the publish/subscribe broker not only receives the last output data of the application before it exited, but also a status alert. The alerted operator/administrator can then look at publications retained (see below) on an output log at the broker to analyse the final output data.

Two additional flags can be set to control operation of Pubtail. The additional flags are “retain” and a quality of service flag indicating a requirement for “assured” delivery, and can be used with either of the modes of operation described above.

The “retain” flag is a feature of the known WebSphere MQ Telemetry Transport (MQTT) protocol, and is interpreted by a WebSphere MQ publish/subscribe message broker as meaning that the last message to be sent to the broker on a particular topic should be stored at the broker. Therefore, when the capture component of Pubtail interfaces with an MQTT messaging client, to send publications to a WebSphere MQ message broker, the last message published by Pubtail is stored in the broker. The newly retained message overwrites a previous retained message on this topic. One advantage of this feature is that a subscriber that is not normally connected to the message broker can subscribe to a dedicated log topic from Pubtail via the broker, and will immediately receive the last message published to that topic. If the monitored application has failed, the last retained message tends to be the crucial message for diagnosis—containing the last lines of the application's output before it failed.

The Assured flag specifies a required “quality of service” option for end-to-end message delivery for messages published by Pubtail and sent to a message broker using MQTT. The Assured flag is of most benefit when a suitable quality of service (generally QoS2) has been selected from the following options provided by MQTT:
QoS0—“send and forget”—which means that, although most messages will be successfully delivered once, some messages may be lost;
QoS1—“at least once delivery”—which uses a simple acknowledgement to ensure each message is eventually delivered even if a network failure occurs, but loss of the acknowledgement message can result in the client application sending the message more than once; and
QoS2—“assured once-only delivery”—which has more message flows in the conversation between the client and the message broker to provide assured once-and-once-only message delivery.

When a message is sent via Pubtail and MQTT with the QoS2 (“assured”) flag set, this is an instruction to the broker to hold on to the message until the subscriber(s) are connected (if the subscribers are not connected at the time of publication). This is a way to ensure that all log messages are received by appropriate subscriber programs, even if the subscriber cannot always be connected. This effectively moves the log from the storage-constrained pervasive device to a data processing system that is better able to store the required quantities of data (in this case, the publish/subscribe broker system).

The messaging program 240 transmits the identified new data to a message broker system 130 located elsewhere in the network, via the MQTT communication protocol. An MQTT-capable messaging program 250 running on the message broker system 130 passes the publication to the publish/subscribe message broker system 130. The publish/subscribe matching engine 50 of the message broker compares a topic identifier within the received publication with a stored subscription list that associates topics with specific subscribers. This identifies zero, one or more subscribers for each publication. The message broker system 130 transmits the publications on across the network to the respective identified subscribers.

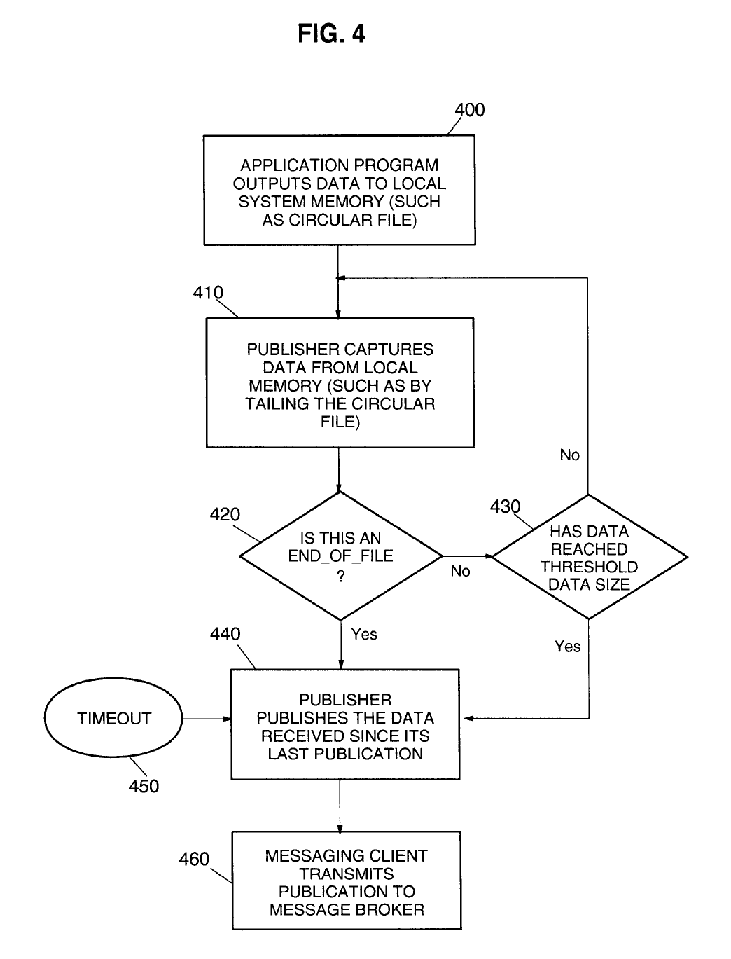

FIG. 4 represents a sequence of steps performed at a monitoring apparatus 200, according to an embodiment of the invention. As described above, an application program 210 running on the monitoring apparatus saves 400 its log data (including diagnostic information) to an in-memory data file 220. A publisher program is also running on the monitoring apparatus 230 and determines command line flags to find out what mode of operation is required. If a permanent connection to the broker is to be used, the publisher program calls a CONNECT method of the MQTT messaging client 240 to make a connection. The publisher application then starts its main processing loop.

While the monitored application is running, the publisher waits for log records received 410 via its input stream. The received log data is log data that has just been saved to the in-memory log file 220, and was extracted, for example, by tailing the log file. In an alternative implementation, the in-memory data file is a ‘named pipe’ between the application program 210 and the publisher program 230—serving the dual roles of being an output queue for the application program 210 and an input queue for the publisher program 230.

The publisher program 230 collects data piped to it or tailed from the in-memory log file 220 until the publisher determines 430 that it has accumulated the required number of bytes or lines of output data to satisfy a publication size criterion. At this point, if not yet connected to the message broker as described above, the publisher program calls the CONNECT method to make a connection to the message broker and then calls a PUBLISH method implemented by the MQTT messaging client to generate 440 a publication message. The generated message contains (as the message payload) the new data captured by the publisher since the publisher last generated and sent a publication message, and contains a pre-defined topic (as well as retain and/or quality of service flags as parameters, if these are required by the mode of operation specified by command line flags). If the publisher is not working in a permanently-connected mode, the publisher calls a DISCONNECT method to disconnect from the remote message broker.

If a timeout occurs 450 before the threshold amount of data has been accumulated by the publisher application 230, the publisher 230 generates 440 a publication with the data currently in its input buffer. If the application terminates, the publisher 230 receives an EndOfFile message on its input stream and determines 420 that the contents of its input buffer should be published. The new publication is sent 460 by a local messaging client 240 that is integrated with the data capture component of the publisher program. The messaging client implements the MQTT protocol, and sends the message to an MQTT-enabled messaging program 250 running at the publish/subscribe message broker system.

The message broker system subsequently performs a comparison between a topic within the publication and a subscription list that maps topics to individual subscribers. This publish/subscribe matching process identifies zero, one or more subscribers for each publication, and the publication is forwarded accordingly.

Some application run-time environments, such as Open Services Gateway initiative (OSGi), allow multiple applications to run in their environment and share common facilities that would otherwise have to be duplicated for each application. Logging and tracing are common examples of such services. Such environments often offer a capability for a user to replace the default logging and tracing capabilities with custom modules. The default capabilities are typically console output or redirection to a log file (as mentioned earlier). In one embodiment of the present invention, the functions of Pubtail described above could be implemented as a custom log or trace facility in such an environment. All applications running in that environment would then automatically be able to be integrated with Pubtail for remote monitoring.

A particular example use of a named pipe is to output data from a Web log, which records each “hit” on a respective Web site. All data sent to the Web log could be identified and published using Pubtail, or Pubtail could add additional filtering such as counting the hits in a period of time, or identifying unique visitors to the Web site, or counting “page views” rather than hits. In one example implementation, Pubtail is able to publish to several topics, with different statistics going to different topics (again, optionally retained or assured). This gives great flexibility in monitoring. (However, web log analysers are well known in the art, but “live” ones are unusual, if not novel).

In one embodiment of the invention, the Pubtail program parses the input stream to identify separate log entries. This is application-specific, but in the case of an HTTP server log each entry is delimited by a line feed character, and is typically in a standard “Common Log Format”. Other delimiters and fixed-length entries are also known. Pubtail can then perform custom logic on the log entry before publishing. For example, Pubtail may extract certain fields from the input data and reformat them to represent the data in a different way. Pubtail may perform “report-by-exception” processing to only publish a message when a parameter changes by more than a threshold amount. Pubtail could implement aggregation—for example how many Web hits per minute are being logged by the HTTP server, or responding to a specific trigger which requires publication of a specific event. The result of all of these custom options for processing by Pubtail is that one or more messages are published on one or more topics (but not necessarily one publication for every log entry). A stream of messages is then sent to the message broker. The messages correspond to certain events or sequences of events that are being experienced by the application program, for events which are only externalised by the application through its log file or via a named pipe to Pubtail. The example of tailing a log file, and filtering and publishing the data, is described in more detail below.

The Pubtail program is configured with a broker address/port, and usually a “root” topic (as there may be several topics being generated by various events, but they will have to be given “context” with a topic prefix). The incoming log data from the tail of the log file is parsed to create individual log records, and then additional application-specific processing is performed to generate the required information. This generated data is then published to an appropriate topic. Different events might be published to different topics, and a single log record could generate 0, 1, or several publications to one or more topics.

As an example, a log monitor for a Web server's log has been implemented to identify Web hits which have resulted in error messages such as a 404-not found error. These are published as messages to the broker, under the topic tree.

The raw data may be, for example:

127.0.0.1 - - [24/Jun/2004:22:09:15 +0100] “GET /callerID/blank.jpg HTTP/1.1” 404 290

127.0.0.1 - - [24/Jun/2004:22:09:15 +0100] “GET /callerID/urlapplet.html HTTP/1.1” 200 552

127.0.0.1 - - [24/Jun/2004:22:09:15 +0100] “GET /callerID/blank.html HTTP/1.1” 404 291

The data published by the log monitor implementation of Pubtail is of the form:

weblog/{response code}/{the path of the requested URL} In the above example, the published data may be:

weblog/404/callerID/blank.jpg

weblog/200/callerID/urlapplet.html

weblog/404/callerID/blank.html

If the ensuing topic space is visualised in an appropriate way, such as shown in FIG. 5, a pictorial view of the problem areas of the site can quickly emerge. This is enhanced further by also identifying the “referrer” in a publication—i.e. identifying the page on which the erroneous link was situated. This can provide a valuable diagnostic tool. This processing and generating a representation of selected events from a log file is applicable to many other applications—including log files of normal output data and logs that are limited to outputs that trigger alerts such as error information. A number of different outputs from a single application may be published on different topics and then forwarded by a publish/subscribe broker to respective subscribers to the different topics.

The log data that is saved can be captured and iteratively published as the log data is generated—i.e. without the significant delays that are common when a log analysis tool is used “retrospectively”.

Thus, various implementations of the invention, including the embodiments described above, can provide the benefits of having a log file associated with an application program. The invention can provide this despite limited storage capacity of an apparatus on which the log data is generated. The invention can also provide the benefits of visible diagnostic information for an application despite the local system being headless, and can provide the benefits of assured delivery of a device's last transmission (or all transmissions) regardless of whether or not the interested parties were connected to the network at the time that transmission was sent.

1-13. (canceled)

14. A method for processing log data that is being generated by an application program that is running in a first data processing system and is being saved to a memory in the first data processing system, said method comprising:
identifying successive units of data in the log data being saved to the memory;
capturing each identified unit of data from the memory;
associating a topic identifier with each captured unit of data;
creating successive publications, each publication comprising at least a captured unit of data and the associated topic identifier; and
transmitting each publication to a topic-based publish/subscribe message broker in a second data processing system.

15. A method according to claim 14 wherein identifying successive units of data further comprises:
monitoring the amount of log data that has been saved since the last unit of data was identified; and
identifying a new unit of data each time the monitored amount reaches a predetermined threshold.

16. A method according to claim 15 wherein the predetermined threshold comprises a predetermined number of bytes of data.

17. A method according to claim 15 wherein the predetermined threshold comprises a predetermined number of lines of log data generated for display as a console output.

18. A method according to claim 14 wherein identifying successive units of data further comprises:
monitoring the amount of time that has elapsed since the last unit of data was identified; and
identifying a new unit of data each time the elapsed time reaches a predetermined threshold.

19. A method according to claim 14 wherein identifying successive units of data further comprises:
monitoring the log data being saved for the presence of one or more key words; and
identifying a new unit of data each time a key word is detected.

20. A method according to claim 14 wherein creating a publication further comprises including an instruction to the topic-based publish/subscribe message broker in the second data processing system to retain the publication at least until a new publication with the same topic identifier has been provided.

21. A method according to claim 14 wherein creating a publication further comprises including an instruction to the topic-based publish/subscribed message broker in the second data processing system to implement assured delivery of the publication to message subscribers who are registered with the message broker to receive publications having the associated topic identifier.

22. A computer program product for processing log data that is being generated by an application program that is running in a first data processing system and is being saved to a memory in the first data processing system, said computer program product comprising a computer usable medium having computer usable program code embodied therewith, said computer usable program code comprising:
computer usable program code configured to identify successive units of data in the log data being saved to the memory;
computer usable program code configured to capture each identified unit of data from the memory;
computer usable program code configured to associate a topic identifier with each captured unit of data;
computer usable program code configured to create successive publications, each publication comprising at least a captured unit of data and the associated topic identifier; and
computer usable program code configured to transmit each publication to a topic-based publish/subscribe message broker in a second data processing system.

23. A computer program product according to claim 22 where the computer usable program code configured to identify successive units of data further comprises:
computer usable program code configured to monitoring the amount of log data that has been saved since the last unit of data was identified; and
computer usable program code configured to identify a new unit of data each time the monitored amount reaches a predetermined threshold.

24. A computer program product according to claim 23 wherein the predetermined threshold comprises a predetermined number of byes of data.

25. A computer program product according to claim 23 wherein the predetermined threshold comprises a predetermined number of lines of log data generated for display as a console output.

26. A computer program product according to claim 22 wherein the computer usable program code configured to identify successive units of data further comprises:
computer usable program code configured to monitor the amount of time that has elapsed since the last unit of data was identified; and
computer usable program code configured to identify a new unit of data each time the elapsed time reaches a predetermined threshold.

27. A computer program product according to claim 22 wherein the computer usable program code configured to identify successive units of data further comprises:
computer usable program code configured to detect the presence of predetermined key words in the data being saved; and
computer usable program code configured to identify a new unit of data each time one of the predetermined key words is detected.

28. A computer program product according to claim 22 wherein the computer usable program code configured to create a publication further comprises computer usable program code configured to include an instruction to the topic-based publish/subscribe message broker in the second data processing system to retain the publication at least until a new publication with the same topic identifier has been provided.

29. A computer program product according to claim 22 wherein the computer usable program code configured to create a publication further comprises computer usable program code configured to include an instruction to the topic-based publish/subscribe message broker in the second data processing system to implement assured delivery of the publication to message subscribers who are registered with the message broker to receive publications having the associated topic identifier.

30. A system for processing log data that is being generated by an application program running in a first data processing system and is being saved to a memory in the first data processing system, said system comprising:
a data unit identifying component for identifying successive units of data in the log data being saved to the memory;
a data capture component for capturing each identified unit of data from the memory;
a topic assignment component for associating a topic identifier with each captured unit of data;
a publication generator for creating successive publications, each publication comprising at least a captured unit of data and the associated topic identifier.

31. A system according to claim 30 wherein the data unit identifying component further comprises:
a component for monitoring the amount of log data that has been saved since the last unit of data was identified; and
a component for identifying a new unit of data each time the amount reaches a predetermined threshold.

32. A system according to claim 31 wherein the predetermined threshold comprises a predetermined number of bytes of data.

33. A system according to claim 32 wherein the predetermined threshold comprises a predetermined number of lines of log data generated for display as a console output.

34. A system according to claim 30 wherein the data unit identifying component further comprises:
a timing component for timing the amount of time that has elapsed since the last unit of data was identified; and
a component for identifying a new unit of data each time the elapsed time reaches a predetermined threshold.

35. A system according to claim 30 wherein the data unit identifying component further comprises:
a key word monitoring component for monitoring the log data being saved for the presence of one or more key words;
a component for identifying a new unit of data each time a key word is detected.

36. A system according to claim 30 wherein the publication generator further comprises a component for including an instruction to the topic-based publish/subscribe message broker in the second data processing system to retain the publication at least until a new publication with the same topic identifier has been provided.

37. A system according to claim 30 wherein the publication generator further comprises a component for including an instruction to the topic-based publish/subscribe message broker in the second data processing system to implement assured delivery of the publication to message subscribers who are registered with the message broker to receive publications having the associated topic identifier.
